(19) United States
(12) Patent Application Publication
(10) Pub. No.: US 2013/0313310 A1
(43) Pub. Date: Nov. 28, 2013

(54) CONSUMER BOX HAVING VENTILATING WINDOWS

(71) Applicants: Denver Schutz, Kingsburg, CA (US); Marco Luna, Reedley, CA (US)

(72) Inventors: Denver Schutz, Kingsburg, CA (US); Marco Luna, Reedley, CA (US)

(73) Assignee: GERAWAN FARMING INC., Fresno, CA (US)

(21) Appl. No.: 13/902,720

(22) Filed: May 24, 2013

Related U.S. Application Data
(60) Provisional application No. 61/651,480, filed on May 24, 2012.

(51) Int. Cl. B65D 81/34; B31B 1/26; B31B 1/86; B31B 1/20

(52) U.S. Cl. CPC B65D 81/34; B31B 1/20; B31B 1/26; B31B 1/86
USPC 229/117.14; 493/68; 493/88; 493/94

(57) ABSTRACT

A consumer box having a lid with ventilating windows. The box can comprise a storage portion and a lid portion. The lid portion may include flaps that can be secured together to form the lid and windows. The subject invention allows the consumer to see the product being stored in the boxes through the windows and also to remove the box from a nested tray using the flaps. The flaps are also secured in such a way that the box, storing a product, may be carried using the flaps. In one embodiment, the boxes are designed to carry fresh produce, and the windows allow for the product to be ventilated so as to maintain the freshness of the produce.

### CROSS-REFERENCE TO RELATED APPLICATION

The present application claims priority to U.S. Provisional Application No. 61/651,480 entitled “Consumer Box Having Ventilating Windows,” filed on May 24, 2012, the entire contents of which are herein incorporated by reference as if fully set forth herein.

### BACKGROUND OF THE INVENTION

The present invention relates generally to consumer boxes for carrying products, and more particularly to a consumer box for storing and carrying fresh produce.

### SUMMARY OF THE INVENTION

The present invention is embodied in a box having a lid with windows that allow a consumer to see the product being stored in the box. In one embodiment, the box is designed so that a plurality of boxes may be stacked next to and on top of each other in a nested tray. The lid comprises flaps that meet in the middle and allow a consumer to pick up the box with one hand out of a nested tray. The flaps may also include finger holes to allow the user to more easily pick up the box. The lid is designed so that it seals the box and has sufficient strength so that it can be lifted and carried with the product stored in the box. The flaps are secured using a latching mechanism whereby the lid has a piece of corrugated paper that is inserted into a slot and locks in place.

In one embodiment, the box is used for storing and carrying fresh produce, such as fruits or vegetables. The windows in the box allow for ventilation of the fresh produce. The box may be designed such that, when a plurality of boxes are stacked in a nesting tray, the windows allow for proper ventilation of the produce so that the freshness of the produce is better maintained. The windows in the lid thus facilitate the consumer's ability to carry the box, maintain the freshness of the produce in the box, and enhance the marketability of the box contents by allowing the consumer to see the produce that is stored inside.

In a particular embodiment, the box is used for storing and carrying stone fruit. In a more particular embodiment, the stone fruit are peaches, and the box is designed to carry four peaches.

In a further embodiment, the box may be printed on and cut out of a single piece of cardboard, paperboard, or other similar medium. The box is then formed by folding the single printed cutout in a prescribed manner.

In a further embodiment, the box contains a tray having cups or cavities wherein the fruit “nests.” These cups or cavities are sized based on the size of the fruit. The tray is made to fit the size of the box. The windows on the lid of the box are strategically placed so the consumer can see the fruit inside the box. The lid is strong enough to support other boxes on top of it, rigid enough to be picked up with one hand using the finger holes, and has windows for the consumer to see what he or she is buying.

The present invention is also embodied in a nesting tray that is designed to carry a plurality of product boxes having windows. In one embodiment, the nesting tray may be designed in such a way that, when a plurality of said boxes are stacked in the nesting tray, products stored in the boxes receive proper ventilation through the windows to maintain the products' freshness. The nesting tray may also be designed such that a consumer may remove a single box from the nesting tray using flaps on the lid of the box.

These and other features and advantages of the invention should become more readily apparent from the detailed description of the preferred embodiments set forth below taken in conjunction with the accompanying drawings, which illustrate, by way of example, the principles of the invention.

### BRIEF DESCRIPTION OF THE DRAWINGS

Embodiments of the present invention will now be described, by way of example only, with reference to the following drawings.

FIG. 1 is a perspective view of a stack of boxes having windowed lids, one of said boxes being picked up by a person, in accordance with an embodiment of the present invention.

FIG. 2 is a top plan view of a plurality of boxes having windowed lids, in accordance with an embodiment of the present invention.

FIG. 3 is a printed cutout for forming a box having a windowed lid, in accordance with an embodiment of the present invention.

### DETAILED DESCRIPTION OF THE PREFERRED EMBODIMENTS

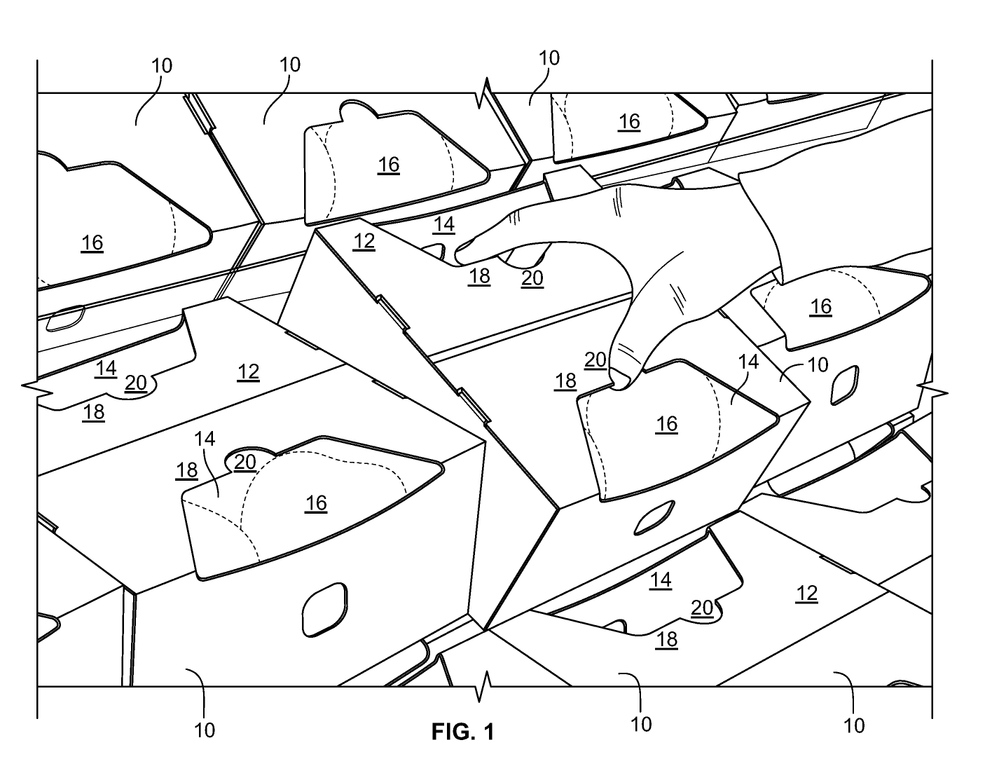

With reference to FIG. 1, there is shown a plurality of boxes 10 in accordance with an embodiment of the present invention. Each box comprises a lid 12 with two windows 14. The box 10 is designed to hold a product 16, in this case, peaches. The box may comprise any appropriate material for storing and carrying the desired product 16. In this particular embodiment, the box may be made of a cardboard or paperboard material, or any other material suitable for storing and carrying fresh produce. The windows 14 allow a consumer to see the product being stored in each box 10. Each lid 12 further comprises two flaps 18 that meet in the center of the box 10. The flaps 18 are secured to each other to form the lid 12. The flaps 18 are designed such that a consumer can remove one box from a nested tray using only one hand. The flaps 18 are secure enough that the box 10 may be carried by the flaps 18 while storing the products 16. The flaps 18 may also include finger holes 20 to allow the user to more easily pick up the box 10. In this particular embodiment, the boxes are designed so that multiple boxes may be stacked next to and on top of each other. The windows in the boxes may be designed to give proper ventilation to products being stored in the boxes, such as fresh produce.

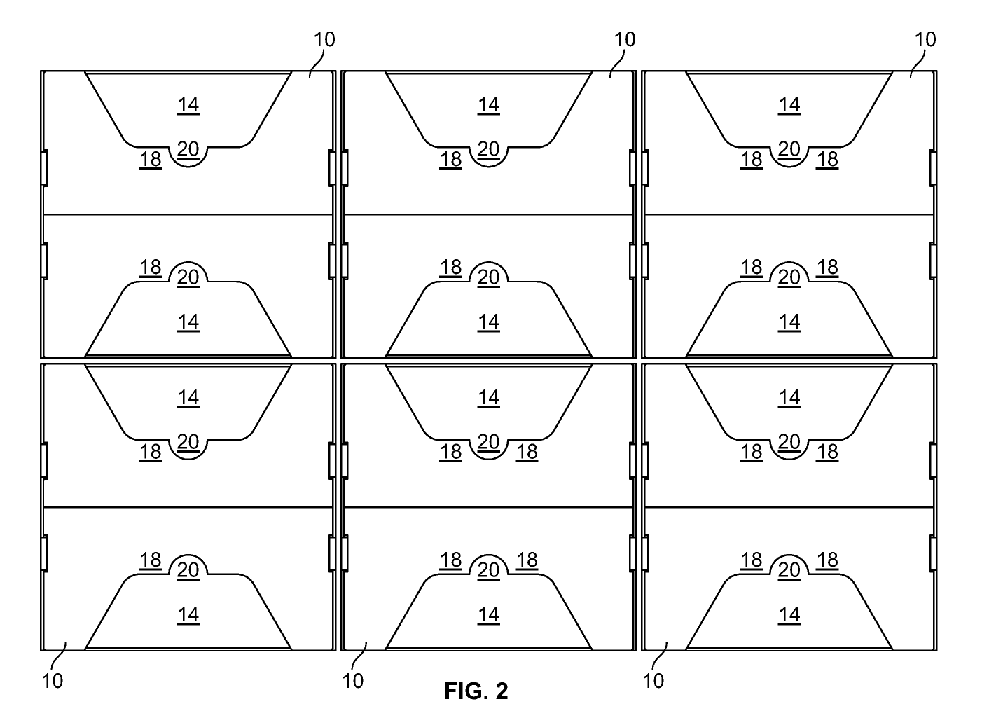

FIG. 2 depicts six boxes 10 arranged next to each other. With a plurality of boxes arranged in this way, and possibly even stacked on top of each other, a consumer can view the products being stored in each box in the top row through windows 14, and can then lift out the single desired box by grabbing flaps 18 by the finger holes 20 of the desired box 10.

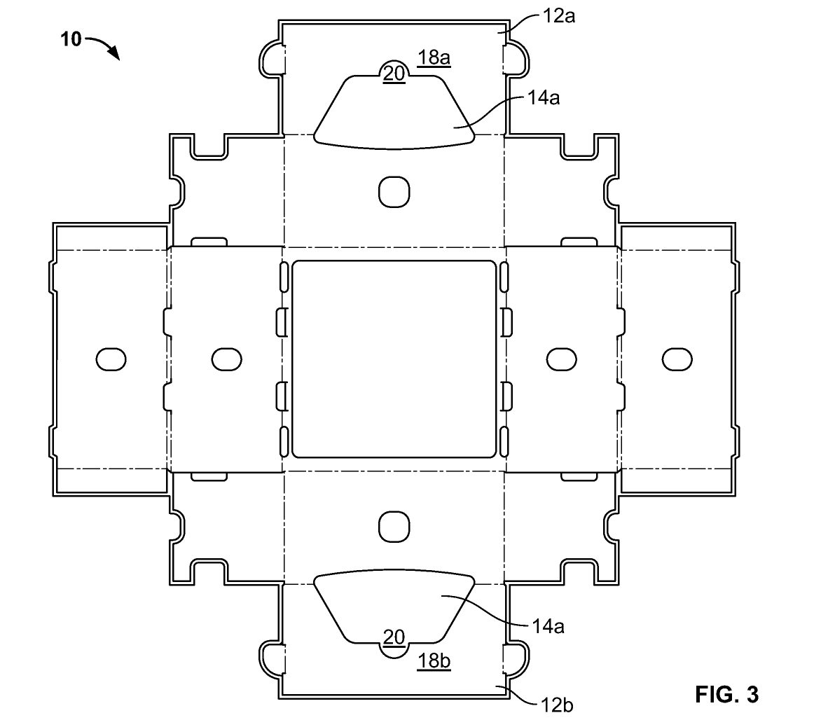

With reference to FIG. 3, there is shown a printed cutout for forming a box 10 having a lid 12 with windows 14. The box 10 is formed by appropriately cutting, folding, and securing along the dotted lines. By printing the box on a single piece of material, such as cardboard or paperboard, the box can be quickly and efficiently manufactured. The lid comprises pieces 12a and 12b, and the lid is formed by joining flaps 18a and 18b at the center of the box 10. Pieces 14a and 14b are cut out to form the windows 14, which provide ventilation for the products being stored in the box 10 and allow consumers to see the products in the box 10.

Although the invention has been disclosed with reference only to the presently preferred embodiments, those of ordinary skill in the art will appreciate that various modifications can be made without departing from the invention. Accordingly, the invention is defined only by the following claims.

What is claimed is:

1. A product box comprising:
a plurality of walls;
a base connected to the plurality of walls; and
a lid, the lid comprising a plurality of flaps, each connected to one of the plurality of walls;
wherein the plurality of flaps are configured to be joined together to form a carrying portion for carrying the box;
wherein the lid further comprises at least one window; and
wherein the product box is substantially formed of a single sheet of paper-based material, the product box being formed by folding the single sheet of paper-based material.

2. The product box of claim 1, wherein the paper-based material is paperboard or cardboard.

3. The product box of claim 1, wherein the product box is configured for storing and carrying fruit.

4. The product box of claim 3, wherein the product box is configured such that, when stacked with other like boxes, the at least one window allows for ventilation of the fruit.

5. The product box of claim 3, wherein the product box further comprises a tray positioned in the product box, wherein
the tray comprises indentations shaped to receive and substantially secure the fruit.

6. The product box of claim 5, wherein the indentations are shaped to receive and substantially secure stone fruit.

7. The product box of claim 6, wherein the indentations are shaped to receive and substantially secure peaches.

8. The product box of claim 1, wherein the at least one window is at least partially defined by one of the plurality of flaps.

9. The product box of claim 1, wherein the carrying portion is configured to allow the product box to be removed from a nested tray with one hand.

10. A produce storage system comprising:
a nested tray having a storage area; and
a plurality of product boxes configured to be stacked in the storage area, each of the plurality of product boxes comprising
a plurality of walls,
a base connected to the plurality of walls, and
a lid, the lid comprising a plurality of flaps, each connected to one of the plurality of walls,
wherein the plurality of flaps are configured to be joined together to form a carrying portion for carrying the box,
wherein the lid further comprises at least one window, and
wherein the product box is substantially formed of a single sheet of paper-based
material, the product box being formed by folding the single sheet of paper-based material.

11. The produce storage system of claim 10, wherein the nested tray is configured such that, when a plurality of product boxes are stacked in the storage area, the product stored in the product boxes receive ventilation through the windows.

12. The produce storage system of claim 10, wherein, the plurality of product boxes are configured for storing and carrying fruit.

13. The produce storage system of claim 10, wherein, the carrying portion of each box is configured such that it allows for a box to be removed from the nested tray with one hand.

14. A method for forming a product box comprising:
printing a box layout onto a single sheet of a paper-based material;
cutting the box layout; and
folding the box layout to form the product box, wherein
the product box comprises
a plurality of walls,
a base connected to the plurality of walls, and
a lid, the lid comprising a plurality of flaps, each connected to one of the plurality of walls,
wherein the plurality of flaps are configured to be joined together to form a carrying portion for carrying the box, and
wherein the lid further comprises at least one window.

15. The method of claim 14, wherein the paper-based material is paperboard or cardboard.

16. The method of claim 14, further comprising the step of inserting a tray into the product box, wherein the tray comprises a plurality of indentations shaped to receive and substantially secure a product.

17. The method of claim 16, wherein the plurality of indentations are shaped to receive and substantially secure fruit.

18. The method of claim 17, wherein the plurality of indentations are shaped to receive and substantially secure stone fruit.

19. The method of claim 18, wherein the plurality of indentations are shaped to receive and substantially secure peaches.
